(19) United States
(12) Patent Application Publication
(10) Pub. No.: US 2010/0055989 A1
(43) Pub. Date: Mar. 4, 2010

(54) Audio jack connector

(76) Inventors: Yu Hung Su, Tu-Cheng City (TW); Yao Ting Wang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,649

(22) Filed: Sep. 3, 2008

(51) Int. Cl. H01R 33/20

(52) U.S. Cl. 439/675

(57) ABSTRACT

An audio jack connector includes an insulating housing and a plurality of terminals received in the insulating housing. The insulating housing has a main body and a mating portion projected from an end of the main body. An inserting channel is defined in both the main body and the mating portion. A plurality of grooves and an opening hole are defined in the main body and communicate with the inserting channel. At least one locking projection is formed in the opening hole. The terminals are at least partially received in the grooves of the insulating housing respectively and at least one of the terminals defines a contacting portion contained in the inserting channel via the opening hole with one end thereof being supported by the locking projection.

### BACKGROUND OF THE INVENTION

1. Field of the Invention

This present invention relates to an electrical connector, and more specifically to an audio jack connector for mating with an audio plug connector.

2. The Related Art

As is known to all, an audio jack connector is arranged in an electronic device to connect with an outside audio plug connector to transmit audio signals. The audio jack connector includes an insulating housing and a plurality of conductive contacts received in the insulating housing. The insulating housing has a main portion and a mating portion extending from the main portion. A channel is defined and passes through the main portion and the mating portion for coupling with the audio plug connector. The insulating housing defines a plurality of contact slits respectively communicating with the channel. The junction of the main portion and the mating portion defines an opening hole for communicating with the channel. Each of the conductive contacts defines a retaining portion fixed in the contact slit, a contact portion protruding into the channel and a connecting portion stretching out of the insulating housing, wherein the contact portion of one conductive contact protrudes in the channel through the opening hole.

However, since a free end of the contact portion that protrudes in the channel through the opening hole is suspended in the channel, thus when mating with the audio plug connector, the contact force of the contact portion is weak, which will likely affect negatively the electrical connection between the contact portion and the audio plug connector.

### SUMMARY OF THE INVENTION

An object of the invention is to provide an audio jack connector comprising an insulating housing and a plurality of terminals received in the insulating housing. The insulating housing has a main body and a mating portion projected from- an end of the main body. An inserting channel is defined in both the mating portion and the main body. A plurality of grooves and an opening hole are defined in the main body and communicate with the inserting channel. At least one locking projection is formed in the opening hole. The terminals are at least partially received in the grooves of the insulating housing respectively and at least one of the terminals defines a contacting portion received in the inserting channel through the opening hole with one end thereof being supported by the locking projection.

As described above, the locking projection securely supports the contacting portion thereon such that the contacting portion elastically deforms greatly to protrude in the inserting channel through the opening hole to match with an audio plug connector inserted in the inserting channel and make a steadily electrical connection between the audio jack connector and the audio plug connector.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of an audio jack connector according to the present invention;

FIG. 2 is a perspective view of an insulating housing of the audio jack connector of FIG. 1;

FIG. 3 is an exploded perspective view of the audio jack connector of FIG. 1; and

FIG. 4 is a cross-sectional view taken along line IV-IV of FIG. 1.

### DETAILED DESCRIPTION OF THE PREFERRED EMBODIMENT

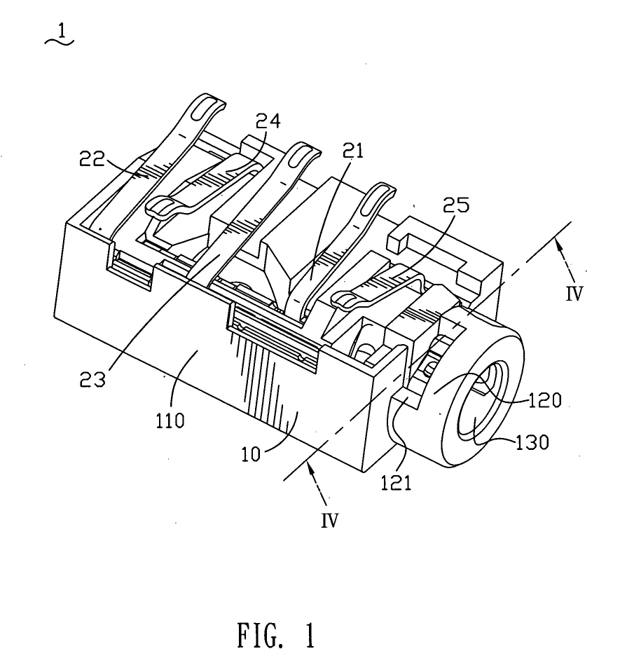

First referring to FIG. 1, an audio jack connector 1 according to the invention is shown. The audio jack connector 1 comprises an insulating housing 10 and a terminal group which is composed of a first terminal 21, a second terminal 22, a third terminal 23, a fourth terminal 24 and a fifth terminal 25.

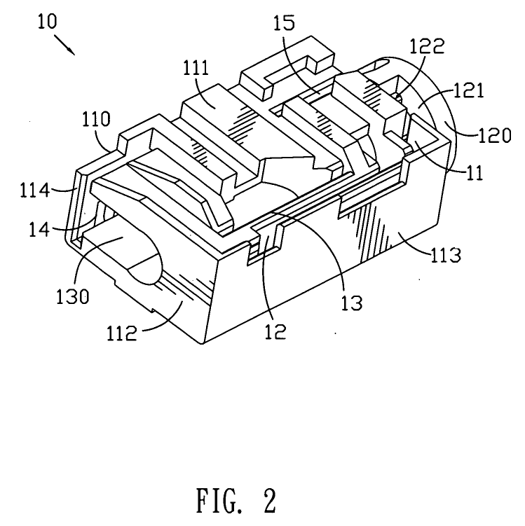

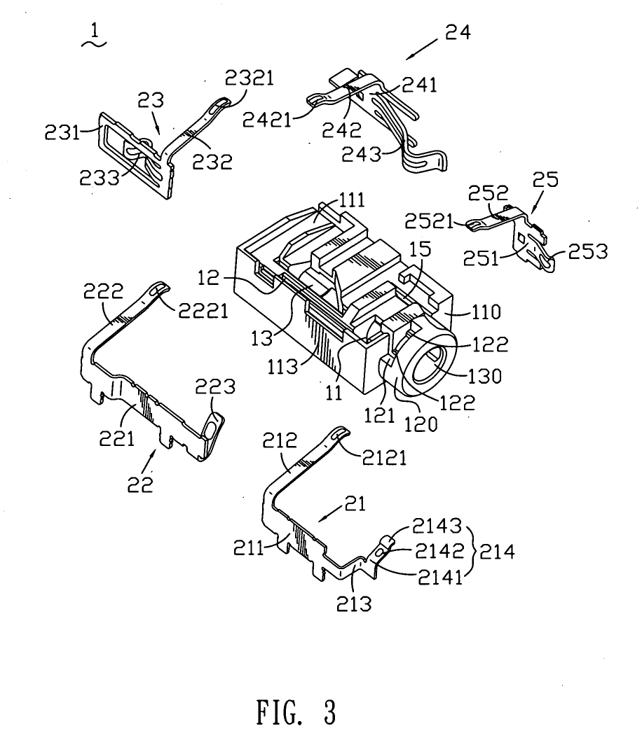

Referring to FIGS. 2 and 3, the insulating housing 10 has a main body 110 and a mating portion 120 projecting out of a front end of the main body 110. A front end surface of the mating portion 120 is opened inward to form an inserting channel 130 which passes through the main body 110. The main body 110 may be of rectangular shape and may include a bottom wall 111, a rear wall 112, a first sidewall 113 and a second sidewall 114.

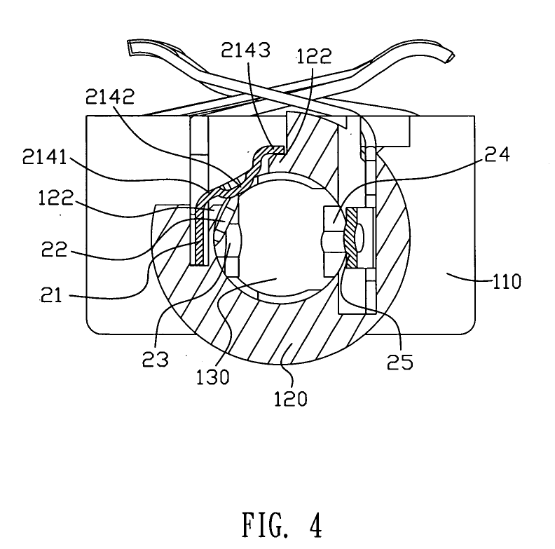

In FIGS. 3 and 4, an opening hole 121 is defined at the junction of the mating portion 120 and the main body 110. The opening hole 121 communicates with the inserting channel 130. Two opposite locking projections 122 protrude toward each other in the opening hole 121.

Referring to FIGS. 2 and 3 again, the bottom wall 111 defines a first groove 11 and a second groove 12, both of which are formed adjacent to the first sidewall 113 and extend along an axial direction of the inserting channel 130. The first groove 11 penetrates the bottom wall 111 and communicates with the opening hole 121. The second groove 12 passes through the bottom wall 111 and communicates with the inserting channel 130. A third groove 13 is also defined in the bottom wall 11. The third groove 13 is adjacent to an inner side of the second groove 12 and also communicates with the inserting channel 130. The bottom wall 111 further defines a fifth groove 15 which is near to the second sidewall 114 and the mating portion 120, and the fifth groove 15 communicates with the inserting channel 130. The rear wall 112 defines a fourth groove 14 passing therethrough and near to the second sidewall 114. The fourth groove 14 also communicates with the inserting channel 130.

Please refer to FIG. 3. The first terminal 21 has a first fixing portion 211 in strip shape. A bottom side of the first fixing portion 211 extends inward to form a first pressing portion 212 adjacent to a rear end of the first fixing portion 21. A rib 2121 is formed on a free end of the first pressing portion 212. A front end of the first fixing portion 211 extends perpendicularly inward and frontward to form a bending portion 213. A bottom side of a free end of the bending portion 213 extends inward to form a first contacting portion 214. The first contacting portion 214 and the first pressing portion 212 are located at the same side of the first fixing portion 211 such that the three portions define substantially a U-shaped construction together. The first contacting portion 214 has a connecting portion 2141 extending from the bending portion 213, a resisting portion 2142 extending from the connecting portion 2141 and a locking portion 2143 extending downward and then extending substantially horizontally inward from the resisting portion 2142.

The second terminal 22 has a second fixing portion 221 in strip shape. A bottom side of the second fixing portion 221 extends inward to form a second pressing portion 222. A free end of the second pressing portion 222 projects to form a rib 2221. An upper side of the second fixing portion 221 extends upward and then extends downward and inward to form a second contacting portion 223. The second contacting portion 223 and the second pressing portion 222 are located at the same side of the second terminal 22.

The third terminal 23 has a third fixing portion 231 in frame shape. A bottom side of the third fixing portion 231 extends inward to form a third pressing portion 232 of which a rib 2321 is projected on a distal end. The third fixing portion 231 defines a rectangular hole (not labeled) and a third contacting portion 233 extending from a front end thereof in the hole and protruding inward.

The fourth terminal 24 has a fourth fixing portion 241. A bottom side of the fourth fixing portion 241 extends to form a fourth pressing portion 242. A rib 2421 is provided on a distal end of the fourth pressing portion 242. A front end of the fourth fixing portion 241 extends forward and protrudes inward to form a fourth contacting portion 243.

The fifth terminal 25 has a fifth fixing portion 251. A middle portion of a bottom side of the fifth fixing portion 251 extends inward to form a fifth pressing portion 252 with a rib 2521 formed on one end thereof. A middle part of a front end of the fifth fixing portion 251 extends frontward and protrudes inward to form a fifth contacting portion 253.

Referring to FIG. 1 and FIG. 4, when the audio jack connector 1 is to be assembled, the first fixing portion 211 of the first terminal 21 is inserted and securely fixed in the first groove 11. The first contacting portion 214 passes into the inserting channel 130 via the opening hole 121. The connecting portion 2141 and the locking portion 2143 of the first contacting portion 214 resist against the two locking projections 122 respectively, so the resisting portion 2142 of the first contacting portion 214 deforms in curve shape and protrudes into the inserting channel 130. The first pressing portion 212 is extended out of the bottom wall 111 of the insulating housing 10. The second fixing portion 221, the third fixing portion 231, the fourth fixing portion 241 and the fifth fixing portion 251 are fixed in the second groove 12, the third groove 13, the fourth groove 14 and the fifth groove 15 respectively. The second contacting portion 223, the third contacting portion 233, the fourth contacting portion 243 and the fifth contacting portion 253 are received into the inserting channel 130 respectively. The second pressing portion 222, the third pressing portion 232, the fourth pressing portion 242 and the fifth pressing portion 252 are exposed out of the bottom wall 111 of the insulating housing- 10 respectively.

When the audio jack connector 1 is used to match with an audio plug connector (not shown), the first pressing portion 212, the second pressing portion 222, the third pressing, portion 232, the fourth pressing portion 242 and the fifth pressing portion 252 are pressed tightly by a printed circuit board (not shown), and as a result, the ribs 2121, 2221, 2321, 2421, 2521 are electrically connected to the printed circuit board. The resisting portion 2142 of the first contacting portion 214 of the first terminal 21 is contained into the inserting channel 130 and connects to the audio plug connector. The second contacting portion 223, the third contacting portion 233, the fourth contacting portion 243 and the fifth contacting portion 253 are also connected to the audio plug connector respectively to transmit audio signals.

As described above, the two locking projections 122 support the connecting portion 2141 and the locking portion 2143 of the first contacting portion 214 thereon, so the resisting portion 2142 elastically deforms greatly to resist against the audio plug connector and make a steadily electrical connection between the audio jack connector 1 and the audio plug connector.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. An audio jack connector, comprising:
an insulating housing having a main body, one end surface of the main body projecting outwardly to form a mating portion, an inserting channel being defined in both the mating portion and the main body, a plurality of grooves and an opening hole being defined in the main body and communicating with the inserting channel, at least one locking projection being formed in the opening hole; and
a plurality of terminals being at least partially received in the grooves of the insulating housing respectively;
wherein at least one of the terminals defines a contacting portion which is received in the inserting channel through the opening hole with one end of the contacting portion being supported by the locking projection.

2. The audio jack connector as set forth in claim 1, wherein the number of the locking projections is two, and the two locking projections are defined at two opposite sides of the opening hole for supporting two opposite ends of the contacting portion.

3. The audio-jack connector as set forth in claim 1, wherein the opening hole is defined at the junction of the mating portion and the main body of the insulating housing.

4. The audio jack connector as set forth in claim 1, wherein the contacting portion further comprises a first fixing portion, a side edge of the first fixing portion extends to form a first pressing portion, one end of the first fixing portion opposite to the first pressing portion extends perpendicularly twice to form a bending portion, and a side edge of the bending portion extends to form the contacting portion at the same side of the first fixing portion as the first pressing portion.

5. The audio jack connector as set forth in claim 2, wherein the contacting portion has a resisting portion extended into the inserting channel, a connecting portion and a locking portion are respectively disposed at opposite sides of the resisting portion, the two locking projections are formed by protruding from the two opposite sides of the opening hole toward each other, the connecting portion and the locking portion resist against the locking projections respectively.
